(19) United States
(12) Patent Application Publication
(10) Pub. No.: US 2005/0135684 A1
(43) Pub. Date: Jun. 23, 2005

(54) Magnitude refinement coding

(76) Inventors: Kumar S. Golla, Plano, TX (US); David K. Vavro, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/742,381

(22) Filed: Dec. 19, 2003

(51) Int. Cl. G06K 9/36

(52) U.S. Cl. 382/232

(57) ABSTRACT

Embodiments of the invention provide a magnitude refinement coding instruction for determining an output context value. When encoding and decoding bit planes, magnitude refinement coding may occur in the magnitude refinement pass. This decision is based on significance state variable Sigma and Eta being zero. When performing magnitude refinement coding, the significance state variables Sigma and Sigma-prime are used to determine the output context (CX) for a bit. Embodiments of the instruction compute a value based on the neighboring quantized coefficients of the quantized coefficient being currently scanned. Based on the computed value and state variable Sigma-prime, an output context (CX) is determined and placed into a destination register along with the current bit value being coded (D).

### RELATED APPLICATIONS

This application is related to U.S. application Ser. No. ______, filed on ______, entitled “Bit-Plane Formatting Including Zero Bit-Plane Detection”; U.S. application Ser. No. ______, filed on ______, entitled “Run Length Coding and Decoding”; U.S. application Ser. No. ______, filed on ______, entitled “Sign Coding and Decoding”; U.S. application Ser. No. ______, filed on ______, entitled “Zero Coding”; and U.S. application Ser. No. ______, filed on ______, entitled “Zero Coding or Run Length Coding Decision.”

### BACKGROUND

The JPEG 2000 standard utilizes transforms and provides a coding scheme and code stream definition for images. (See JPEG2000 standard, Information Technology—JPEG 2000 Image Coding System: Core Coding System, ISO/IEC FDIS 15444-1: 2000 JPEG Image Coding System, incorporated herein by reference.) Under the JPEG 2000 Standard, each image may be divided into rectangular tiles. If there is more than one tile, the tiling of the image creates tile-components. After tiling of an image, the tile-components are decomposed into one or more different decomposition levels using a wavelet transformation. These decomposition levels contain a number of sub-bands populated with coefficients that describe the horizontal and vertical spatial frequency characteristics of the original tile-components. The coefficients provide frequency information about a local area, rather than across the entire image. In particular, a small number of coefficients completely describe a single sample.

In JPEG2000, the arithmetic coding and decoding is performed bit-plane by bit-plane, from the most significant bit plane to the least significant bit plane. This reveals a weak point in processors, as they are not efficient when operating in the bit plane level in 2D.

### BRIEF DESCRIPTION OF THE DRAWINGS

FIG. 1 illustrates a block diagram of one embodiment of a coder embodying the invention.

FIG. 2 illustrates a block diagram of one embodiment of a DWT decomposing an original image into subbands.

FIG. 3 illustrates a diagram of an exemplary embodiment of a code-block scan pattern of a code-block.

FIG. 4 illustrates a block diagram of one embodiment of registers storing values for significance state variables sigma and sigma-prime to be used to determine context values during the magnitude refinement pass.

FIG. 5 is an embodiment of a system for implementing embodiments of the invention.

FIG. 6 is a flowchart of an embodiment for bit modeling.

### DETAILED DESCRIPTION

The principles of the arrangement described herein have general applicability to coding symbols representative of transform coefficients of one or more blocks of a digital image. For ease of explanation, the preferred embodiment is described with reference to JPEG2000. However, it is not intended that the present invention be limited to the described arrangement. For example, the invention may have application to bit-plane coding techniques in general and other coding techniques.

In JPEG2000, discrete wavelet transform coefficient bits are arranged into code-blocks and coded in bit plane order using three coding passes for each bit plane. A code-block is defined as a rectangular block within a sub-band. The coefficients inside the code-block are coded a bit plane at a time, starting with the most significant bit plane having a non-zero element and ending with the least significant bit plane.

For each bit plane in a code-block, a particular code-block scan pattern is used for each significance propagation, magnitude refinement and cleanup pass. Each coefficient bit is coded only once in one of the three passes. The pass in which a coefficient bit is coded depends on the conditions for that pass. For each pass, contexts are created using the significance states of neighboring coefficient bits of the coefficient bit currently being coded. The context is passed to an arithmetic coder along with the bit stream to effect entropy coding.

Embodiments of the invention provide a magnitude refinement coding instruction for determining an output context value. When encoding and decoding bit planes, magnitude refinement coding may occur in the magnitude refinement pass. This decision is based on bit significance state variable Sigma and Eta being zero. When performing magnitude refinement coding, the significance state variables Sigma and Sigma-prime are used to determine the output context (CX) for a coefficient bit. Embodiments of the instruction compute a value based on the neighboring quantized coefficients of the quantized coefficient being currently scanned. Based on the computed value and state variable Sigma-prime, an output context (CX) is determined and placed into a destination register along with the current coefficient bit value being coded (D).

In the detailed description, numerous specific details are set forth in order to provide a thorough understanding of the present invention. However, it will be understood by those skilled in the art that the present invention may be practiced without these specific details. In other instances, well-known methods, procedures, components and circuits have been described in detail so as not to obscure the present invention.

Some portions of the detailed description that follow are presented in terms of algorithms and symbolic representations of operations on data bits or binary signals within a computer. These algorithmic descriptions and representations are the means used by those skilled in the data processing arts to convey the substance of their work to others skilled in the art. An algorithm is here, and generally, considered to be a self-consistent sequence of steps leading to a desired result. The steps include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities. Unless specifically stated otherwise as apparent from the following discussions, it is appreciated that throughout the specification, discussions utilizing such terms as “processing” or “computing” or “calculating” or “determining” or the like, refer to the action and processes of a computer or computing system, or similar electronic computing device, that manipulate and transform data represented as physical (electronic) quantities within the computing system's registers and/or memories into other data similarly represented as physical quantities within the computing system's memories, registers or other such information storage, transmission or display devices.

Embodiments of the present invention may be implemented in hardware or software (microcode), or a combination of both. However, embodiments of the invention may be implemented as computer programs executing on programmable systems comprising at least one processor, a data storage system (including volatile and non-volatile memory and/or storage elements), at least one input device, and at least one output device. Program code may be applied to input data to perform the functions described herein and generate output information. The output information may be applied to one or more output devices, in known fashion. For purposes of this application, a processing system includes any system that has a processor, such as, for example, a digital signal processor (DSP), a micro-controller, an application specific integrated circuit (ASIC), or a microprocessor.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

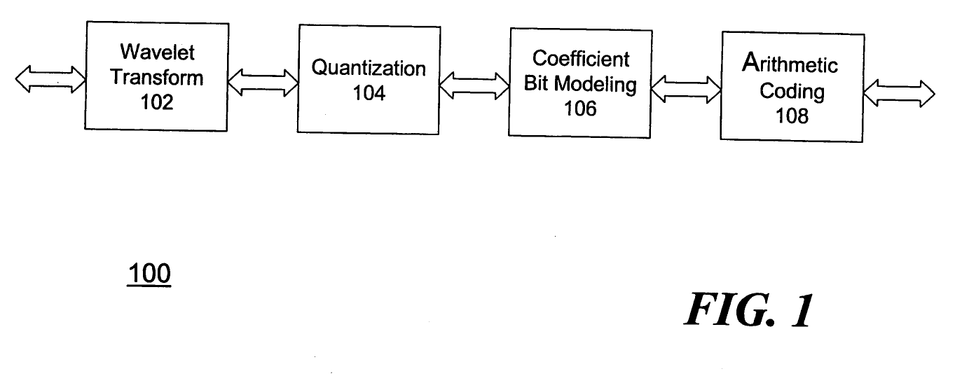

Before proceeding with a description of the preferred arrangement, a brief review of the JPEG2000 coding method is given. Referring to FIG. 1, a block diagram of one embodiment 100 of a coder embodying the invention is illustrated. As mentioned previously, JPEG2000 divides a whole image into one or more image tile components, each of which are then 2-D discrete wavelet transformed. The transform coefficients of each image tile component are then grouped into sub-bands, which sub-bands are further partitioned into rectangular code blocks before each code block is then entropy encoded.

In particular, embodiment 100 of coder includes a discrete wavelet transform (DWT) 102, quantizer 104, coefficient bit modeler 106 and entropy coder 108 suitable for compressing images in accordance with JPEG2000. The original image is first divided into tiles. These tiles are rectangular arrays that include the same relative portion of all the components that make up the image. Thus, tiling of the image actually creates tile-components that can be decoded independently of each other. These tile-components can also be extracted and reconstructed independently. This tile independence provides one of the methods for extracting a region of the image.

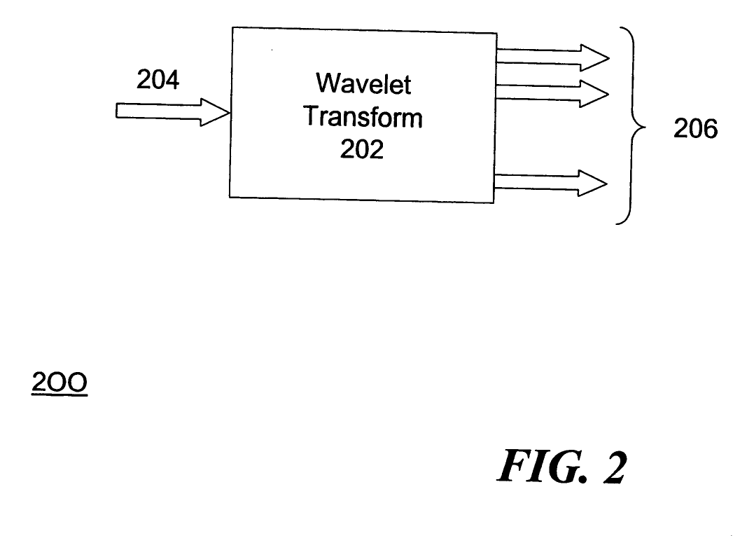

FIG. 2 illustrates a block diagram of one embodiment 200 of a DWT 202 decomposing an original image 204 into subbands 206. The tile components are decomposed into different decomposition levels using a wavelet transform. These decomposition levels contain a number of sub-bands populated with coefficients that describe the horizontal and vertical spatial frequency characteristics of the original tile-component planes. The coefficients provide frequency information about a local area, rather than across the entire image. That is, a small number of coefficients completely describe a single sample. A decomposition level is related to the next decomposition level by spatial powers of two. That is, each successive decomposition level of the sub-bands has approximately half the horizontal and half the vertical resolution of the previous. Images of lower resolution than the original are generated by decoding a selected subset of these sub-bands.

For example, a first DWT stage decomposes the original image (LL₀) into four sub-bands, denoted by the labels LL₁, HL₁, LH₁, and HH₁. The labels indicate the filtering and decomposition level (LL₁=low-pass filtering horizontally, low-pass filtering vertically, at the 1st level of decomposition). These sub-bands are populated with wavelet coefficients that describe spatial frequency characteristics of the original image. The second stage further breaks down LL₁ into the four sub-bands LL₂, HL₂, LH₂, and HH₂. Although only three such stages are shown in FIG. 2, this process may continue for many stages. Each LLn sub-band is a reasonable low resolution rendition of LLₙ₋₁ with half the width and height.

Although there are as many coefficients as there are samples, the information content tends to be concentrated in just a few coefficients. Through quantization 104, the information content of a large number of small magnitude coefficients is further reduced. Additional processing by the entropy encoder reduces the number of bits required to represent these quantized coefficients, sometimes significantly compared to the original image.

The individual sub-bands of a tile-component are further divided into code-blocks. These rectangular arrays of coefficients can be extracted independently. In particular, each sub-band, comprised of coefficients produced in the DWT, is subjected to uniform scalar quantization in the quantization step. The quantized coefficients of the sub-bands are further broken down into two-dimensional arrays (for example, 64×64 or 32×32 samples) called code-blocks.

The coefficients are associated with different sub-bands arising from the transform applied. These coefficients are then arranged into rectangular blocks with each sub-band, called code-blocks. These code-blocks are then coded a bit-plane at a time starting from the most significant bit-plane with a non-zero element to the least significant bit-plane.

For each bit-plane in a code-block, a special code-block scan pattern is used for each of the coding passes. Each coefficient bit in the bit-plane is coded in only one the three coding passes. The coding passes are called significance propagation, magnitude refinement, and cleanup. For each pass, contexts are created which are provided to the arithmetic coder, CX, along with the bit stream, CD. The arithmetic coding step uses the context vectors and the corresponding coefficients to create a compressed data stream. The arithmetic coder is reset according to selected rules.

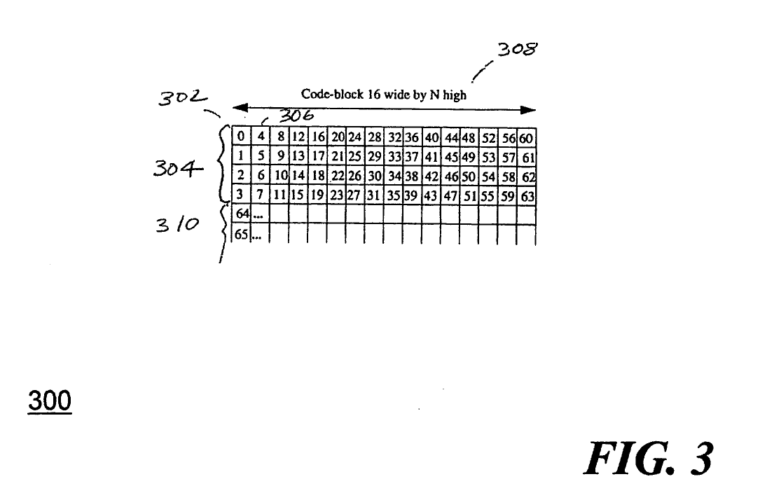

As stated above, the code-blocks of quantized coefficients are coded with three coding passes. These coding passes are performed on “bit planes,” each of which is an array consisting of bits taken from the same position in each coefficient. The first bit plane is comprised of the most significant bits (MSB) of all the coefficient magnitudes in the code-block. The second bit-plane is comprised of the second MSBs of all the coefficient magnitudes in the code-block, and so on. Referring to FIG. 3, each quantized coefficient has four bits, for example, a₁, a₂, a₃, a₄. The MSB of each coefficient has a subscript of “1,” for example, a₁. The first bit plane is comprised of a₁, b₁, c₁, d₁, the second bit-plane is comprised of a₂, b₂, c₂, d₂ and so forth until the least significant bits (LSB).

FIG. 3 is a diagram of an exemplary embodiment 300 of a code-block scan pattern of a code-block. Each bit-plane is scanned in a particular order. Starting at the top left 302, the first four bits of the first column 304 are scanned. Then the first four bits of the second column 306, until the width 308 of the code-block has been covered. Then the second four bits 310 of the first column are scanned and so on. A similar vertical scan is continued for any leftover rows on the lowest code-blocks in the sub-band.

This scan pattern is followed in each of the three coding passes. The decision as to in which pass a given bit is coded is made based on the “significance” of that bit's location and the significance of neighboring locations. A location is considered significant if a 1 has been coded for that location (quantized coefficient) in the current or previous bit planes.

The first pass is called the significance propagation pass. A bit is coded in this pass if its location is not significant, but at least one of its eight-connected neighbors is significant. If a bit is coded in this pass, and the value of that bit is “1,” its location is marked as significant for the purpose of coding subsequent bits in the current and subsequent bit planes. Also, the sign bit is coded immediately after the “1” bit just coded.

The second pass is the magnitude refinement pass (MRP), where all bits from the locations that became significant in a previous bit plane are coded.

The third and final pass is the clean-up pass, where bits not coded in the first two passes are taken care of. The results of these three scanning passes are the context vectors for the quantized coefficients.

In accordance with embodiments of the invention, when encoding and decoding bit planes, magnitude refinement may occur in the magnitude refinement pass. When a sample is already significant, magnitude refinement is used to encode the new bit position. This decision is based on bit state variables Sigma and Eta being zero. When performing magnitude refinement coding, the state variables Sigma's and Sigma-prime are used to determine the output context (CX). The D output is simply equal to the current coding bit of the magnitude.

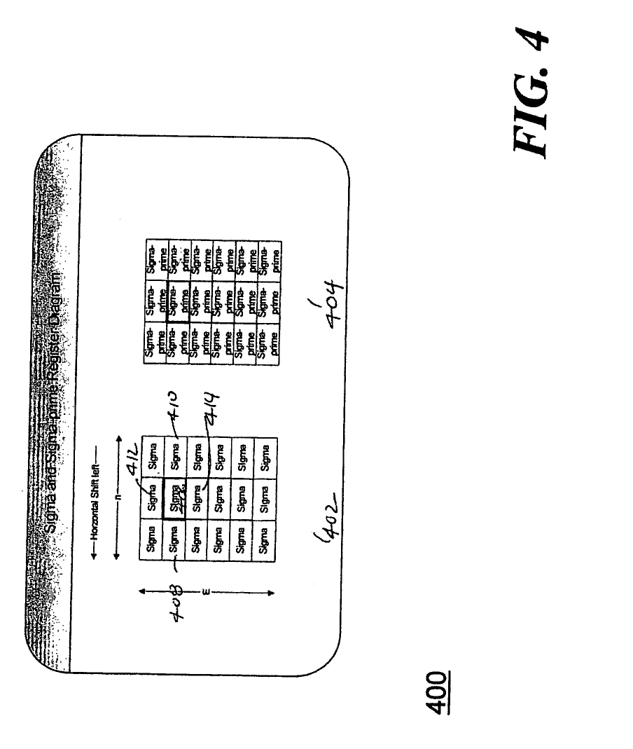

FIG. 4 is a block diagram of an embodiment 400 of registers 402, 404 for significance state variables sigma and sigma-prime. In particular, the significance state variables Sigma and Sigma-prime are shown aligned in a processor's register set. The array of state variables sigma and sigma-primes correspond to an array of quantized coefficients being scanned.

Embodiments of the magnitude refinement coding instruction will center on coefficient bit 406 in bold and the surrounding neighbors. In the code segment, the state variable of the quantized coefficient being currently scanned is located at 406. Embodiments of the instruction will compute a value x based on the state variable sigma states of the immediate horizontal and vertical neighboring bits according to Eq. 1 as follows:
x=Sigma[m,n−1]+Sigma[m,n+1]+Sigma[m−1,n]+Sigma[m+1,n] (Eq. 1)
where m=row and n=column

In particular, m and n values are centered around the Sigma associated with selected coefficient bit 406. Sigma[m, n−1] corresponds to immediate horizontal left neighbor bit 408, Sigma[m, n+1] corresponds to immediate horizontal right neighbor bit 410, Sigma[m−1, n] corresponds to immediate vertical top neighbor bit 412, Sigma[m+1, n] corresponds to bit immediate horizontal vertical bottom neighbor bit 414. Embodiments of the instruction can be used for coding four bits in one group. For example, the selected processing location 406 can include up to 3 sigma bits down.

Based on the computed x value and the state variable Sigma-prime, the output context (CX) may be determined. For example, as shown in TABLE 1, if Sigma-prime has a value of “1,” X would not have to be calculated and the context value would be set to “16.” Embodiments of the magnitude refinement instruction will also set the current Sigma-prime bit to a “1” after the context pair (CX,D) is calculated and delivered to the destination register. The context output values of “16,” “15,” and “14” are for exemplary purposes. Embodiments of the invention are not restricted to these or any values noted.

TABLE 1

| Sigma-prime | X | CX |
|---|---|---|
| 1 | x | 16 |
| 0 | >=1 | 15 |
| 0 | 0 | 14 |

The output context CX is placed into a destination register along with the current bit value being coded (D) as shown in TABLE 1. The magnitude refinement coding according to the presently preferred embodiment of the invention may be implemented in response to an instruction set including a magnitude refinement coding instruction. When implementing this instruction, the host processor controls (either directly or indirectly) the magnitude refinement coding. In general, the exact operation sequence to be performed is based on the contents of the block master data structure, which contains the information of the current coefficient block which is being processed. The block master data structure can be implemented in either software or hardware, depending on the embodiment. In the presently preferred embodiments, the block master data structure is implemented as hardware, specifically, as a register set. The registers may include sigma and sigma prime state variable registers (which may be implemented as a set of two registers) which contains the quantized coefficient values of the stripe currently being scanned and significance values. These registers can be connected directly with the memory storage containing the coefficient values, or updated under control of the host processor. During encoding, these register may be scanned to produce the information required to control the operation sequences in the codec.

In a conventional configuration, a processor would have to mask out Sigma bits from 4 locations and add them together to determine x. This would require 4 “AND” and 3 “add” instructions. The Sigma-prime would have to be masked and checked for a “0” or “1” value requiring another instruction. If a “1” value is detected, the x value would not have to be calculated and CX=16. Then the Sigma-prime has to be set to a “1” after the context pair CX, D is stored to a register, which would require two instructions for read-modify-write bit. The context pair CX, D must be packed and stored to a register, requiring two instructions for read-pack-write. Assuming Sigma-prime is a zero 50% of the time, then 7×0.5=3.5 instructions on average are needed to determine x. In a conventional configuration, the total instructions on average to perform magnitude refinement coding would be 3.5+1+2+2=8.5 instructions per bit.

This is in contrast to the single instruction required for MR coding according to embodiments of the present invention. In particular, to code a 64×64 pixel block with 15 magnitude bits, magnitude refinement coding may be performed once in each bit plane. Assuming that the average time magnitude refinement coding is performed is 25% of the time in each bit case, the total times that magnitude refinement coding might occur is 64×64×15×0.25=15360. Thus, with the addition of this instruction to a processor performing JPEG2000 would save 8.5×15360=130560 instructions for just a 64×64 pixel block.

A signal processor or a general processor can JP2000 bit plane coding and decoding at a much higher rate. If this instruction is included in the instruction set, the processor has a greater advantage than without one when supporting JPEG2000.

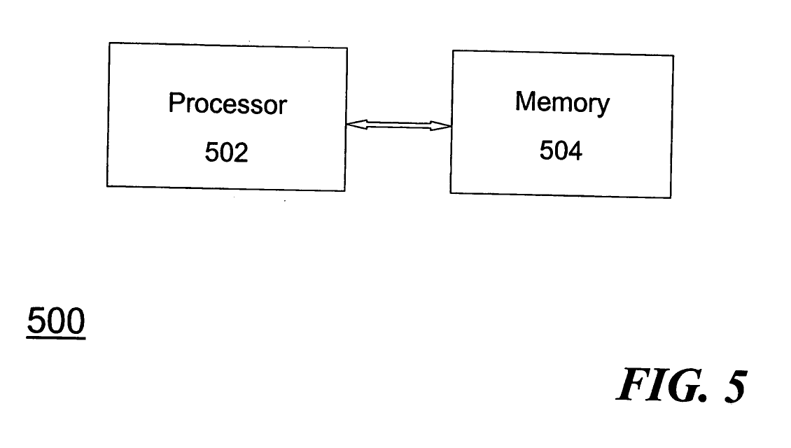

FIG. 5 is an embodiment of a system 500 for implementing embodiments of the invention. In particular, the system includes a processor 502 and memory 504. As noted above, for purposes of this application, a processing system includes any system that has a processor, such as, for example, a digital signal processor (DSP), a micro-controller, an application specific integrated circuit (ASIC), or a microprocessor. The system may be specially constructed for the required purposes, or it may comprise a general purpose computer selectively activated or reconfigured by a computer program stored in the computer. The processor 502 may be configured to format images compatible with the JPEG2000 format. In response to a selected bit to be processed with the magnitude refinement pass, the processor executes an instruction stored in the memory to generate a context value for the selected bit.

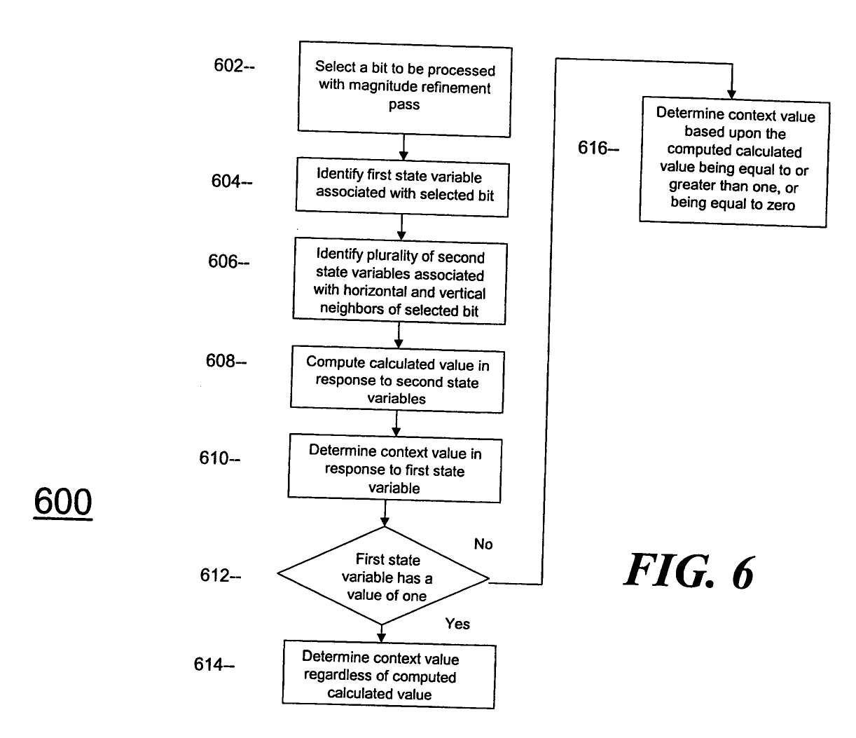

FIG. 6 is a flowchart 600 of an embodiment for bit modeling.

In step 602, a bit is selected to be processed with a magnitude refinement pass.

In response to a selected bit to be processed with the magnitude refinement pass (step 602), an instruction is executed to generate a context value for the selected bit.

In particular, in step 604, a first bit state variable associated with the selected bit to be processed is identified.

In step 606, a plurality of second bit state variables associated with horizontal and vertical neighboring bits of the selected bit to be processed identified.

In step 608, a calculated value is computed in response to the second bit state variables. In one implementation, this comprises adding the second bit state variables associated with horizontal and vertical neighboring bits of the selected bit to be processed.

In step 610, a context value in response to the first bit state variable and calculated value is determined. In response to the first bit state variable having a first value, such as a value of one (step 612), the context value is determined regardless of the computed calculated value (step 614). In response to the first bit state variable having a second value, such as a value of zero, the context value is determined based upon the computed calculated value being equal to or greater than the first value, such as one, or the computed calculated value being equal to the second value, such as zero (step 616). For a computed calculated value being equal to or greater than the first value, such as one, a context value is determined. For a computed calculated value being equal to a second value, such as zero, a context value is determined.

The above description of illustrated embodiments of the invention is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. Embodiments of the invention may be implemented in digital signal processors as well as standard processors because of the capabilities it provides for processing applications such as JPEG2000 as well as existing applications such as JPEG. These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method for bit modeling, comprising:
selecting a bit is to be processed with a magnitude refinement pass;
in response to a selected bit to be processed with the magnitude refinement pass, executing an instruction to generate a context value for the selected bit, comprising:
receiving a first bit state variable associated with the selected bit to be processed;
receiving a plurality of second bit state variables associated with horizontal and vertical neighboring bits of the selected bit to be processed;
computing a calculated value in response to the second bit state variables; and
determining a context value in response to the first bit state variable and calculated value.

2. The method claimed in claim 1, wherein computing a calculated value in response to the second state variables further comprises:
adding the second bit state variables associated with horizontal and vertical neighboring bits of the selected bit to be processed.

3. The method claimed in claim 1, wherein determining a context value in response to the first bit state variable and calculated value further comprises:
in response to the first bit state variable having a first value, determining the context value regardless of the computed calculated value.

4. The method claimed in claim 1, wherein determining a context value in response to the first bit state variable and calculated value further comprises:
in response to the first bit state variable having a value of second value, determining the context value based on the computed calculated value being equal to or greater than the first value.

5. The method claimed in claim 1, wherein determining a context value in response to the first bit state variable and calculated value further comprises:
in response to the first bit state variable having a second value, determining the context value based on the computed calculated value being equal to a first value.

6. A system, comprising:
a memory; and
a processor to determine a selected bit to be processed with a magnitude refinement pass, wherein in response to a selected bit to be processed with the magnitude refinement pass, the processor executes an instruction stored in the memory to generate a context value for the selected bit, comprising:
receiving a first bit state variable associated with the selected bit to be processed;
receiving a plurality of second bit state variables associated with horizontal and vertical neighboring bits of the selected bit to be processed;
computing a calculated value in response to the second bit state variables; and
determining a context value in response to the first bit state variable and calculated value.

7. The system claimed in claim 6, wherein computing a calculated value in response to the second state variables further comprises:
adding the second bit state variables associated with horizontal and vertical neighboring bits of the selected bit to be processed.

8. The system claimed in claim 6, wherein determining a context value in response to the first bit state variable and calculated value further comprises:
in response to the first bit state variable having a value of one, determining the context value regardless of the computed calculated value.

9. The system claimed in claim 6, wherein determining a context value in response to the first bit state variable and calculated value further comprises:
in response to the first bit state variable having a value of zero, determining the context value based on the computed calculated value being equal to or greater than one.

10. The system claimed in claim 6, wherein determining a context value in response to the first bit state variable and calculated value further comprises:
in response to the first bit state variable having a value of zero, determining the context value based on the computed calculated value being equal to zero.

11. A machine readable medium having stored therein a plurality of machine readable instructions executable by a processor to bit model, comprising:
instructions to select a bit to be processed with a magnitude refinement pass;
in response to a selected bit to be processed with the magnitude refinement pass, executing an instruction to generate a context value for the selected bit, comprising:
instructions to receive a first bit state variable associated with the selected bit to be processed;
instructions to receive a plurality of second bit state variables associated with horizontal and vertical neighboring bits of the selected bit to be processed;
instructions to compute a calculated value in response to the second bit state variables; and
instructions to determine a context value in response to the first bit state variable and calculated value.

12. The machine readable medium claimed in claim 11, wherein instructions to compute a calculated value in response to the second state variables further comprises:
instructions to add the second bit state variables associated with horizontal and vertical neighboring bits of the selected bit to be processed.

13. The machine readable medium claimed in claim 11, wherein instructions to determine a context value in response to the first bit state variable and calculated value further comprises:
in response to the first bit state variable having a value of one, instructions to determine the context value regardless of the computed calculated value.

14. The machine readable medium claimed in claim 11, wherein instructions to determine a context value in response to the first bit state variable and calculated value further comprises:
in response to the first bit state variable having a value of zero, instructions to determine the context value based on the computed calculated value being equal to or greater than one.

15. The machine readable medium claimed in claim 11, wherein instructions to determine a context value in response to the first bit state variable and calculated value further comprises:
in response to the first bit state variable having a value of zero, instructions to determine the context value based on the computed calculated value being equal to zero.
